(19) United States
(12) Patent Application Publication
(10) Pub. No.: US 2004/0153294 A1
(43) Pub. Date: Aug. 5, 2004

(54) Top-down multi-objective design methodology

(76) Inventor: Trent Lorne McConaghy, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/480,853

(22) PCT Filed: Jun. 17, 2002
(86) PCT No.: PCT/CA02/00882

(51) Int. Cl. G06F 17/50

(52) U.S. Cl. 703/1; 716/1

(57) ABSTRACT

The present top-down multi-objective design methodology leverages multi-objective optimization/synthesis technology to enable a powerful way to handle complex designs, and to maximize IP reuse. This methodology is top-down in that the system is described in a hierarchical manner of larger subsystems containing progressively smaller subsystems. It leverages multi-objective technology by automatically determining tradeoffs for each node at each level of the hierarchy and using these tradeoffs to determine the design space of the node's parent node. The present invention is suitable for any combination of optimization, synthesis, or manual design at every level.

### FIELD OF THE INVENTION

The present invention relates generally to design methodology, in particular, a top-down design methodology.

### BACKGROUND OF THE INVENTION

Design methodologies are required to make complex designs feasible and manageable. Known design methodologies are usable but suffer from various drawbacks.

Two known existing design methodologies include: the top-down constraint-driven design methodology; and the bottom-up design methodology.

Referring to FIG. 1, a top-down constraint-driven design methodology begins with a specific design aim 100 (e.g. the design of an A/D converter) which has certain constraints (e.g. power consumption<10 mW). Next, taking into account the constraints, the elements/components of that design aim are specified (see FIG. 2). Each of the second level components 110, 120 and 130 are decomposed in terms of third level components 112, 114, 122 and 124 (see FIG. 3). This continues until the bottom level (leaf) components are specified (see FIG. 4). The components can be designed or a known design (e.g. from a database or reference collection) can be used. Next, referring to FIG. 5, the design is verified from bottom-up. Typically, the bottom-up verification phase is more accurate than the top-down design phase and more information is known about the design.

The drawback of this methodology is evident if a redesign is required. Referring to FIG. 6, if there is a problem, for example, where a lower level component 112 cannot meet the given constraints, then those constraints must be loosened, requiring the redesign of its parent component 110. However, referring to FIGS. 7 and 8, this may result in the inability of the parent component 110 to meet its constraints, requiring further loosening of the constraints for its parent, which is design aim 100. Consequently, the requirement to change a single lower level component could propagate up the entire hierarchy requiring massive redesign and constraint modifications. In the worst case scenario, the redesign of design aim 100 is not possible within its constraints thereby requiring modification of its (top level) constraints which is typically very undesirable and may entail unacceptable business cost.

Although the top-down constraint-driven design methodology uses hierarchical abstraction to manage the complexity of the design project and supports parallel design efforts, it typically relies on past experience with similar problems to set “reasonable” constraints and, it may turn out that these constraints need to be loosened.

As constraints are changed, there are iterative up-and-down changes to the components. More importantly, top-down constraint-driven design methodology forces architecture selection up-front and is directed to identifying feasible designs without any assurance of efficiency or optimality.

An alternative known methodology is the bottom-up design methodology. Referring to FIG. 9, the methodology begins with a desired design aim 200. Then “anticipated to be needed” bottom level or “leaf” components 212, 214, 222 and 224 are designed and verified. The leaf components are used to design and verify components at the parent-of-the-leaf level as illustrated by nodes 210, 220 and 230 in FIG. 10. This process is repeated at each level until the root level design aim 200 is designed and verified using the components at the children-of-the-root level, as shown in FIG. 11.

However, disadvantageously, if constraints of a component such as design aim 210 are not satisfied, then a sub-block must be redesigned, as illustrated in FIG. 12. Although the bottom-up design is simple, it suffers from the problems of wasted effort when “anticipated needs” of components are wrong. In addition, the absence of a rigorous formal structure can result in many iterations among levels in the hierarchy.

Abstracting from the examples of these two methodologies, the benefits of a good methodology include: handling of massive complexity; minimization of design time; minimization of the number of people required; and maximization of design quality, preferably by giving some assurance of the optimality of results.

In addition, desirable features of a good methodology include: few or no iterations in the design process; providing a suitable level of useful information to the user; hierarchical modelling of the problem; explicit modelling of a database of useful results; supporting parallel efforts of people to speed up design time; and leveraging the power of design tools.

It is, therefore, desirable to provide a design methodology that overcomes the disadvantages of the known prior art while striving for the enumerated benefits and features of a good design methodology.

### SUMMARY OF THE INVENTION

It is an object of the present invention to obviate or mitigate at least one disadvantage of previous design methodologies.

According to an aspect of the present invention, there is provided a method of determining a design satisfying a design aim, the method comprising: identifying at least one candidate component of the design; determining at least one component discrete tradeoff curve for the at least one candidate component; generating a design space containing the at least one component discrete tradeoff curve; and determining at least one design from the design space. The step of determining at least one component discrete tradeoff curve for at least one component can comprise: identifying at least one candidate subcomponent for the at least one component; determining at least one subcomponent discrete tradeoff curve for the at least one candidate subcomponent; generating a component design space containing the at least one subcomponent discrete tradeoff curve; and determining at least one subcomponent design from the subcomponent design space.

According to another aspect of the present invention, there is provided a method of designing a design aim having one or more components and subcomponents, the method comprising: top-down planning of components and subcomponents for potential inclusion in a design; constructing a sorted list of components and subcomponents; and bottom-up generation of tradeoffs curves of subcomponents and using the generated tradeoffs curves of subcomponents to define a design space for a corresponding component.

According to a further aspect of the present invention, there is provided A method of determining a design satisfying a design aim, the method comprising: identifying a design aim; associating goals with the design aim; identifying one or more candidate components and subcomponents for potential inclusion in the design; determining for each subcomponent a subcomponent tradeoff curve; determining for each component a component design space based on its subcomponents; determining a component tradeoff curve for each component based on the determined component design space; determining a design space based on the component tradeoff curves; and determining a design based on the determined design space.

According to a still further aspect of the present invention, there is provided A system for determining a design satisfying a design aim, the design having one or more components, the system comprising: means for providing a design aim to the system; means for associating goals with the design aim; means for identifying one or more candidate components and subcomponents for potential inclusion in the design; means for determining a subcomponent tradeoff curve for each subcomponent; means for determining a component design space based on the subcomponent tradeoff curves of the component's subcomponents; means for determining, for each component, a component tradeoff curve based on the determined component design space; means for determining a design space based on the component tradeoff curves; and means for determining a design based on the determined design space;

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is shows top level node according to a known top-down constraint-driven methodology;

FIG. 2 shows a continuation of the methodology of FIG. 1 where the components of the top level node are established;

FIG. 3 shows a continuation of the methodology of FIG. 3 where the components of the top level nodes are designed and a further level of (leaf) nodes have been established;

FIG. 4 shows a continuation of the methodology of FIG. 3 where the components of the leaf nodes have been designed;

FIG. 5 shows a continuation of the methodology of FIG. 4 illustrating the verification of the designs of all components;

FIG. 6 shows a continuation of the methodology of FIG. 5 illustrating the loosening of constraints for a leaf node and the redesign of the parent of the leaf node;

FIG. 7 shows a continuation of the methodology of FIG. 6 illustrating the loosening of constraints for an intermediate node and the redesigning of the parent of the intermediate node;

FIG. 8 shows a continuation of the methodology of FIG. 7 illustrating the loosening of constraints for a top node and the modification of higher level constraints;

FIG. 9 shows the “anticipation” of necessary components by the design and verification of leaf nodes in the design of a top level node according to a known bottom-up design methodology;

FIG. 10 shows a continuation of the methodology of FIG. 9 illustrating the design and verification of intermediate nodes (parents of leaf nodes);

FIG. 11 shows a continuation of the methodology of FIG. 10 illustrating the design and verification of the top node;

FIG. 12 shows a continuation of the methodology of FIG. 11 illustrating the redesign of an intermediate node and its descendant leaf nodes when the design of the top node does not satisfy its constraints;

FIG. 13 is a high level flow chart showing a top-down multi-objective design method according to an embodiment of the present invention;

FIG. 14 shows a top level design component having goals according to another embodiment of the present inventinon;

FIG. 15 shows a continuation of the methodology of FIG. 14 illustrating “may contain” components of the top level component;

FIG. 16 shows a continuation of the methodology of FIG. 15 illustrating “may contain” components of the intermediate components;

FIG. 17 shows a continuation of the methodology of FIG. 17 illustrating the generation of tradeoff curves and verification at two leaf nodes;

FIG. 18 shows a continuation of the methodology of FIG. 17 illustrating the incorporation of the tradeoff curves of an the two third level leaf nodes the design space of intermediate node;

FIG. 19 shows a continuation of the methodology of FIG. 18 illustrating the generation of tradeoff curves and verification at the two second level nodes (one is a leaf node);

FIG. 20 shows a continuation of the methodology of FIG. 19 illustrating the incorporation of the tradeoff curves of the two second level nodes into the design space of the top node;

FIG. 21 shows a continuation of the methodology of FIG. 20 illustrating the generation of a tradeoff curve and verification FIG. 22 shows a discrete and a continuous tradeoff curve;

FIG. 23 shows an example of the methodology of FIG. 13 in which “may contain” relationships are identified;

FIG. 24 continues the example of FIG. 23 and shows a list of component types;

FIGS. 25 to 29 continue the example of FIG. 24 and shows the finding of the (optimal) tradeoffs for different components;

FIG. 30 shows the tradeoffs at the system level;

FIG. 31 shows nondominated and dominated points FIG. 32 shows a synthesis space for a filter; and

FIG. 33 shows points in objective space (or objective function space) with and without random fluctuations.

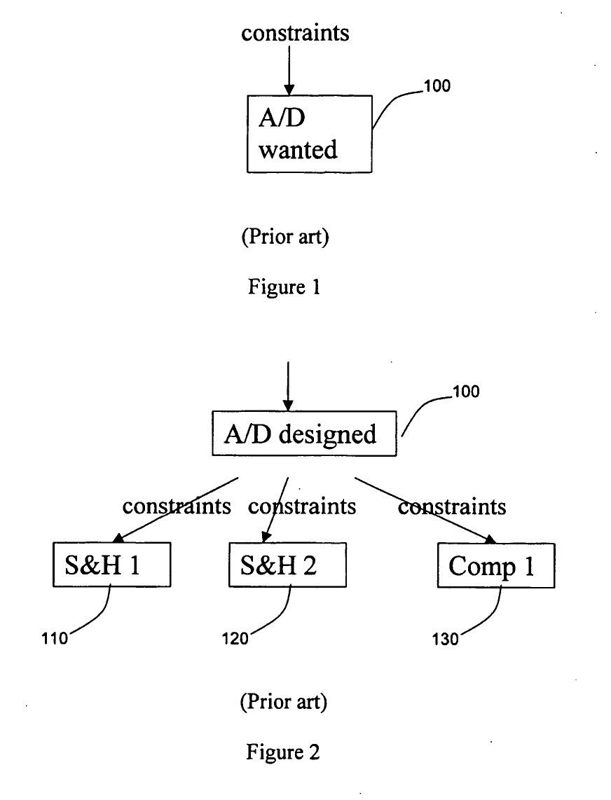

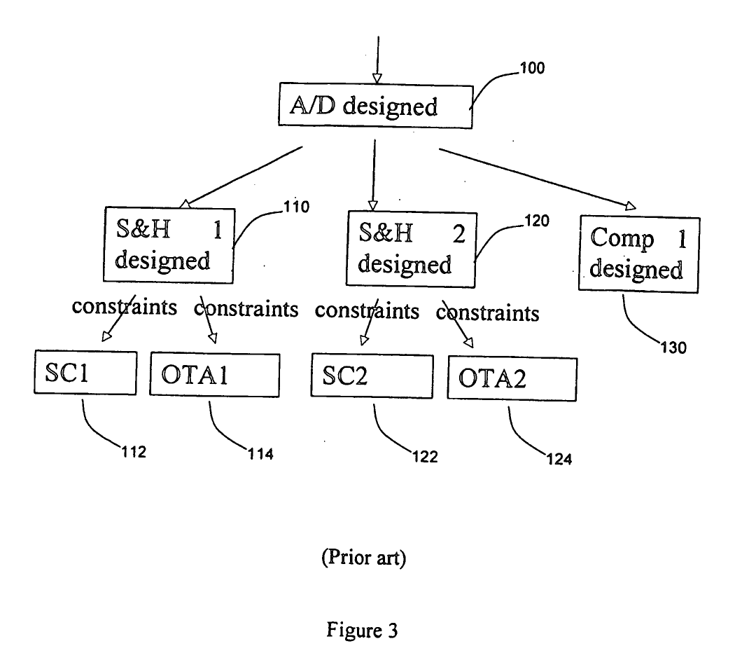

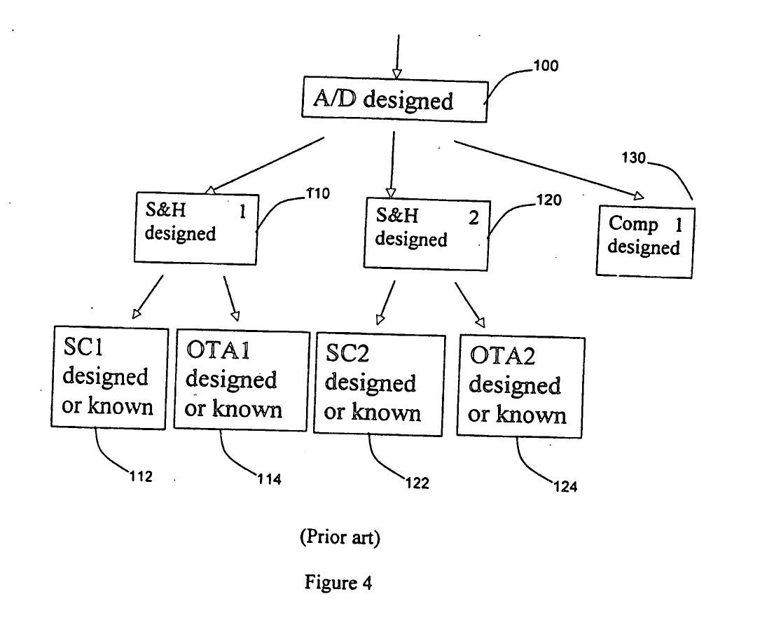

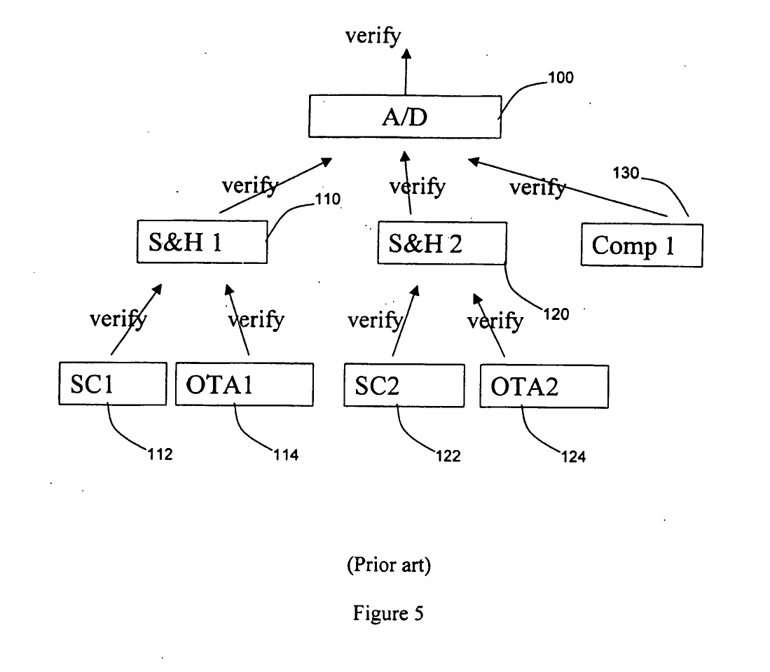

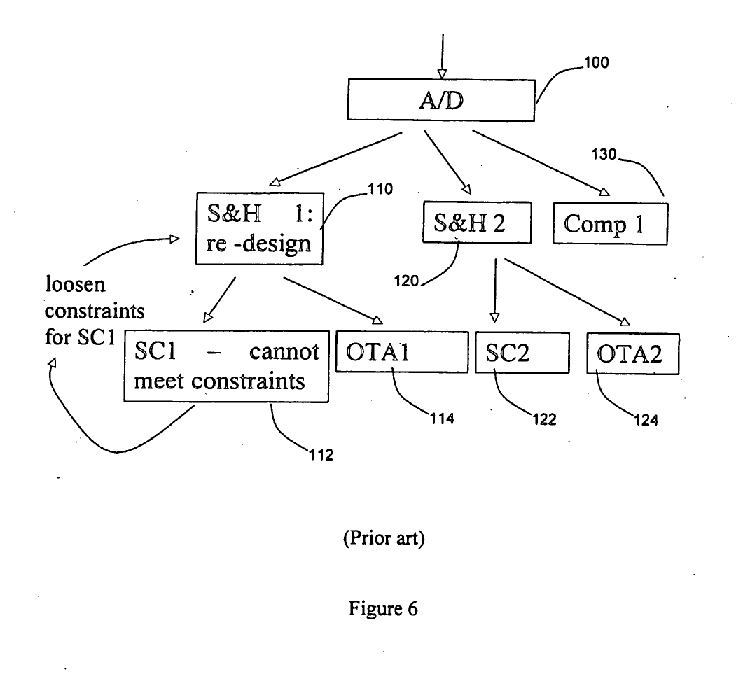

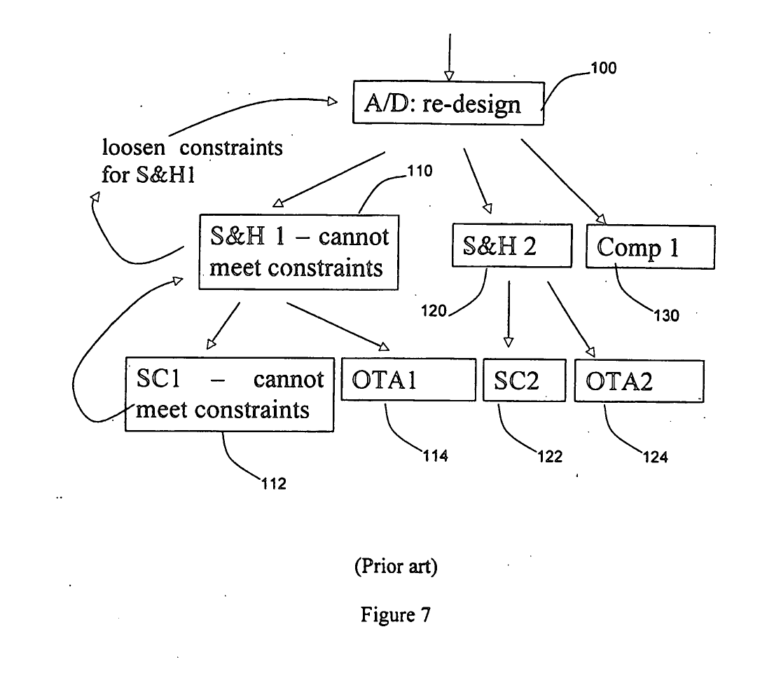

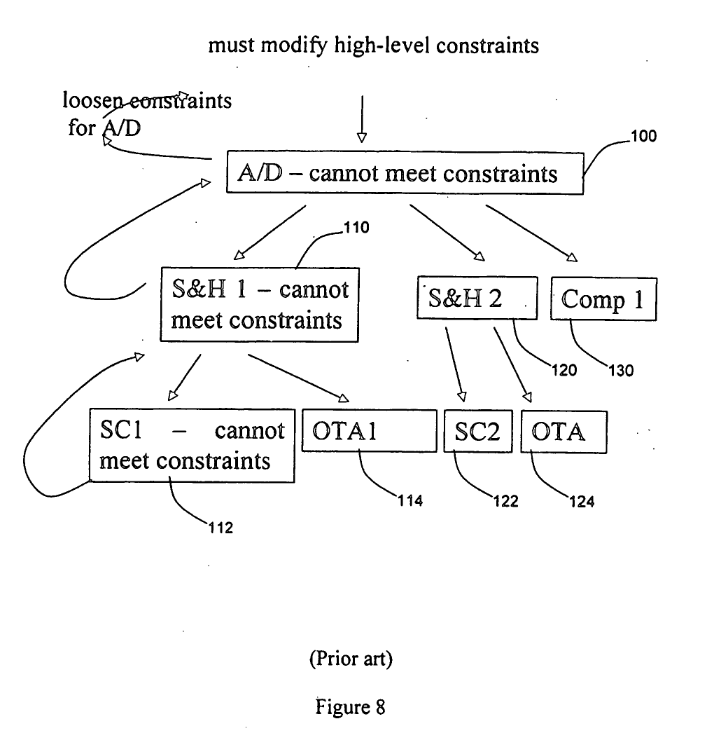

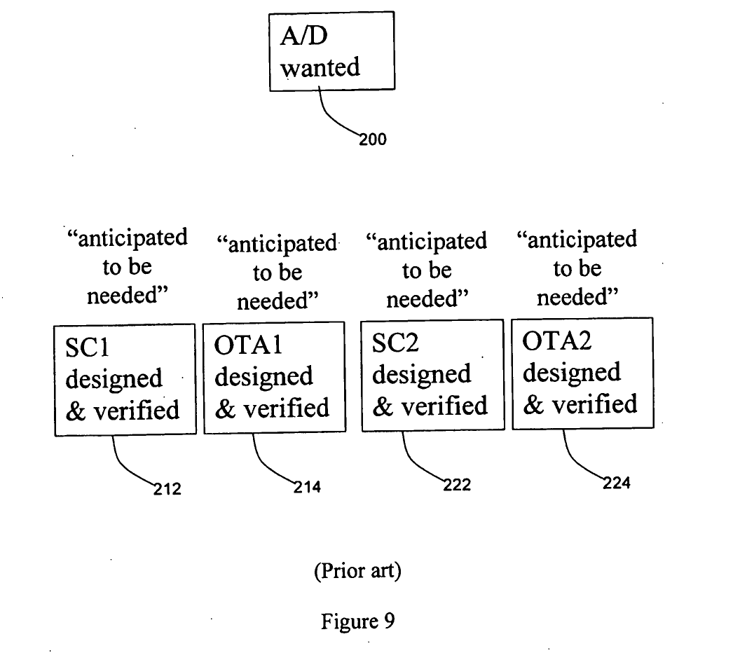

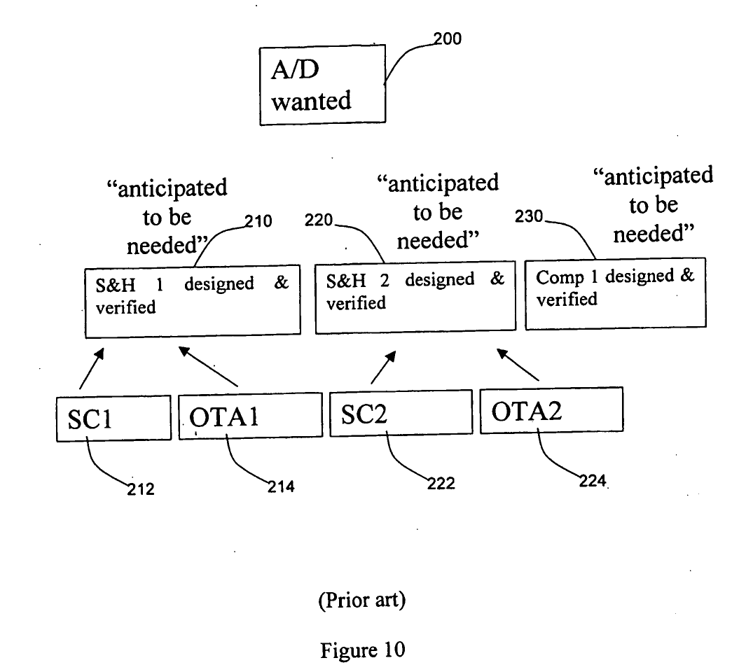

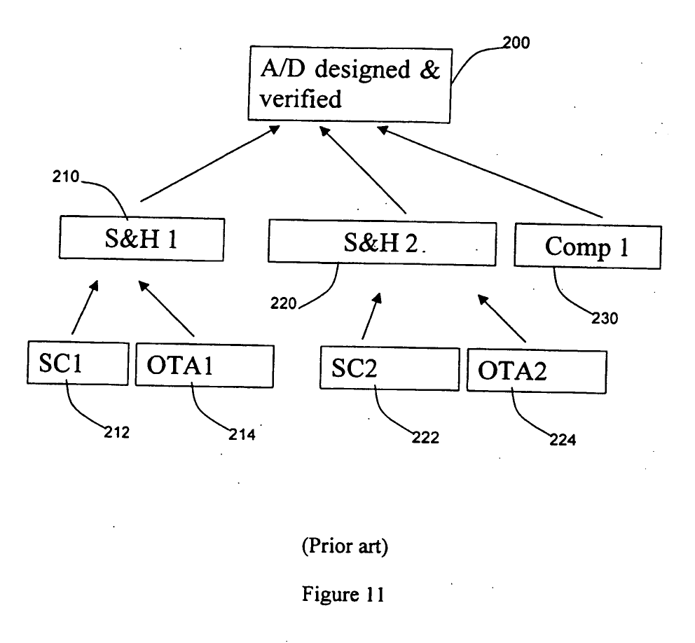

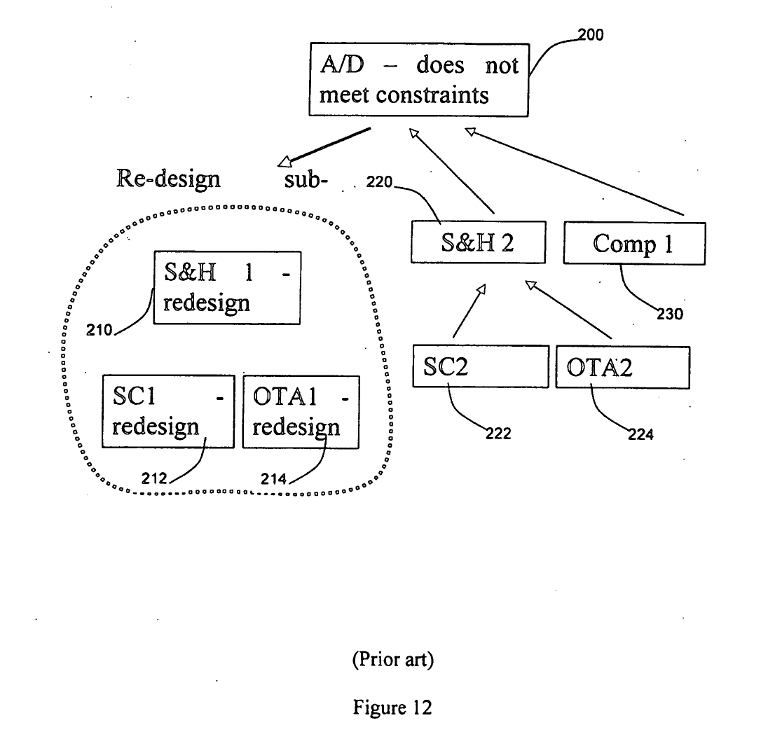

### DETAILED DESCRIPTION

Generally, the present invention provides a method and system for a top-down multi-objective design methodology. This methodology leverages multi-objective optimization/synthesis technology to enable a powerful way to handle complex designs, and to maximize IP reuse. This methodology is applicable to numerous domains, including any in which a design aim is required. The embodiments discussed below relate to examples from the electronic design automation industry but the methodology of the present example is by no means limited to that example application. Other example applications include ones relating to: optical components; networking applications, micro-electromechanical machines (MEMs), computation, scheduling problems and management problems.

This methodology is top-down in that the system is described in a hierarchical manner of larger subsystems containing progressively smaller subsystems. It leverages multi-objective technology by automatically determining tradeoffs for each node at each level of the hierarchy. It works for any combination of optimization, synthesis, or manual design at every level.

For greater certainty, we clarify our use of the following terms. By “design space”, we refer to the set of possible designs. For example, when working with circuits designs, a design space is typically the set of architectures and parameters for circuits that can be varied during a design process. By “design aim” we mean the objective sought after by the design process or methodology. By “goals” we mean the objectives and constraints which are to be satisfied by the design. By “component”, we mean design component which can but need not be a physical component.

Note that design can, but need not, refer to the design of a physical object. For example, component could refer to a subroutine or algorithm in the design of a larger algorithm.

One can view the optimization/synthesis of goals for a system as the mapping of an n-dimensional design space for the system into an m-dimensional “objective function space”. By the expression “tradeoff curve” we mean the set of non-dominated points in objective function space. However, see the discussion below regarding non-dominated design spaces.

As emphasized below, the present invention relates to discrete non-dominated points in objective function space. Accordingly, the tradeoff curve is not continuous and should be thought of as consisting of finitely many points or countably many points. Of course, the “curve” is in general m-dimensional corresponding to the rank of the objective function space. By extension, we can also think of the tradeoff curve as the relationship defined by the non-dominated points.

For clarity, consider the following example: the design aim is a vehicle for transporting a user; goals include the constraint of having two or more wheels and the two objectives of minimizing cost and maximizing stability. Two designs (defining a trade off curve) are: a bicycle having a frame, seat, two wheels and a drive train as components; and a tricycle having a frame, a seat, three wheels and a drive train as components. The bicycle has lower cost but lower stability as well so there is a trade off between the two designs (neither bicycle nor tricycle dominate each other).

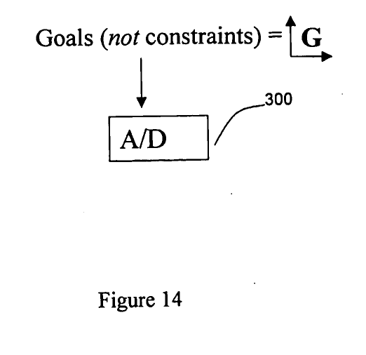

Referring to FIG. 14, according to the present invention, we begin with a top level design aim which has goals. At least one of the goals should be an objective and not a constraint otherwise the top level problem can be modeled, for example, by top-down constraint-driven methodology. However, a sub-tree having an objective-goal can use the present methodology. In the example of FIG. 14, the design aim 300 is the design of an A/D converter which has certain goals.

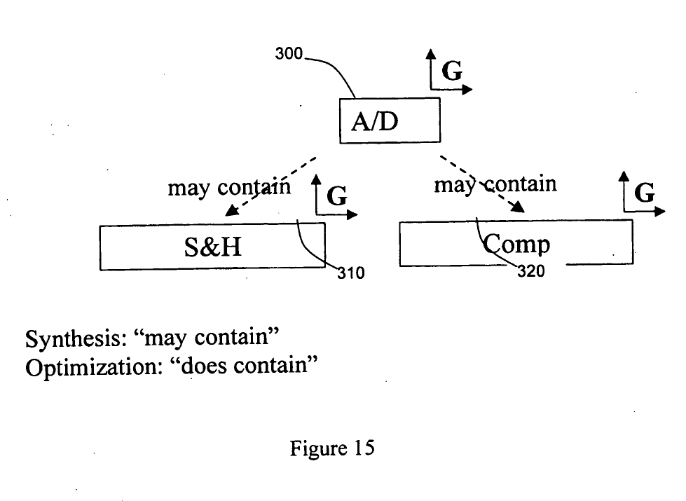

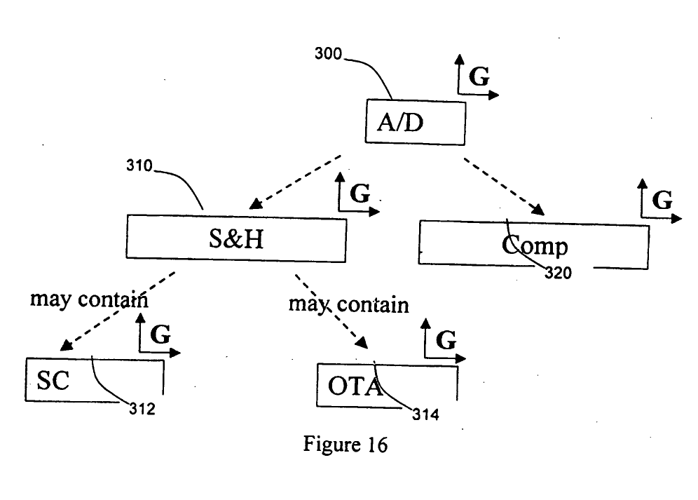

Referring to FIG. 15, “may contain” relationships are specified for design aim 300 in terms of its components 310 (subnodes). These subnodes are candidate components for potential inclusion in one or more final designs. Note that the subnodes 310 also have associated goals. The “may contain” relationship means that a node contains zero or more instances of a subnode. This process is applied to the subnodes 310, 320. For example, as illustrated in FIG. 16, subnode 310 has “may contain” relationships with its subnodes 320 and 322. This continues until all nodes except leaf nodes have “may contain” relationships with their subnodes. In the present example, nodes 312, 314 and 320 are leaf nodes.

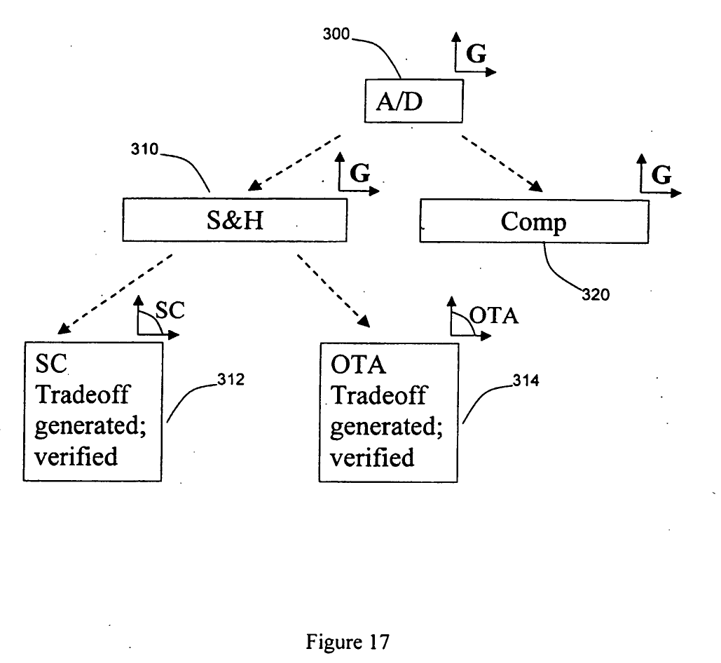

Referring to FIG. 17, at leaf nodes 312 and 314 tradeoffs are generated between the goals of the SC and OTA components based on their respective design spaces. The design spaces can either be generated or already known, for example by reference to a database.

Accordingly, for each component and based on its design space, its associated goals and a corresponding objective function, a discrete set of points (the tradeoff curve) in objective function space are generated. This can, but need not, be done by an optimizer in which case, each point is non-dominated.

Note that we refer to a discrete set of points. This is more useful than a continuous set of points since there is no guarantee that a continuous set of points exists. Of course if a continuous set does exist, a discrete subset can always be selected from the continuous set. See FIG. 22.

In addition, we can have some measure of assurance that each point corresponds to an existing or known design whereas in the continuous case, it may be necessary to resort to interpolation, extrapolation or some other artifice. As a practical matter, typical components have discrete values such as a fixed resistance. As indicated in FIG. 17, the tradeoffs are also verified.

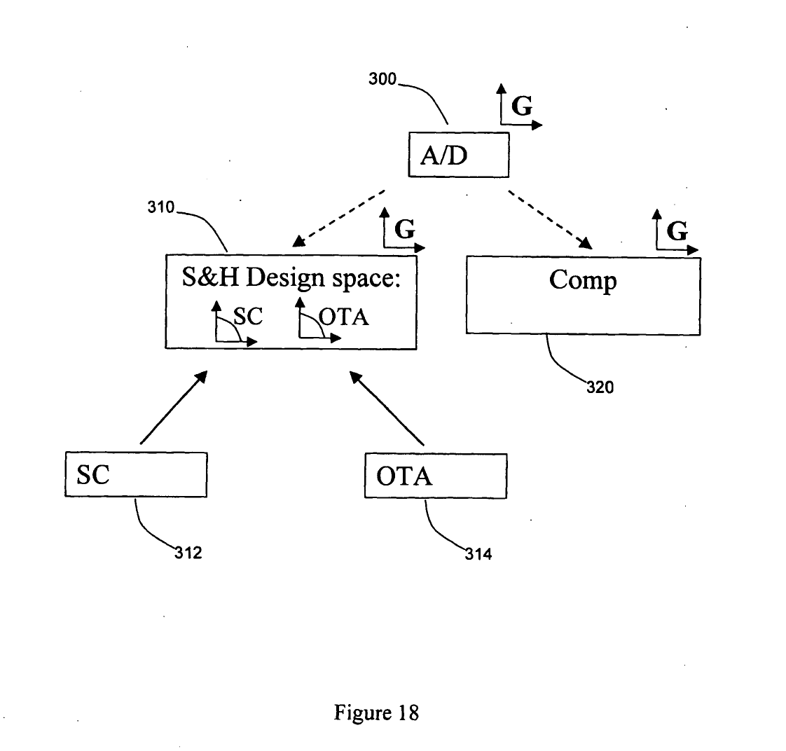

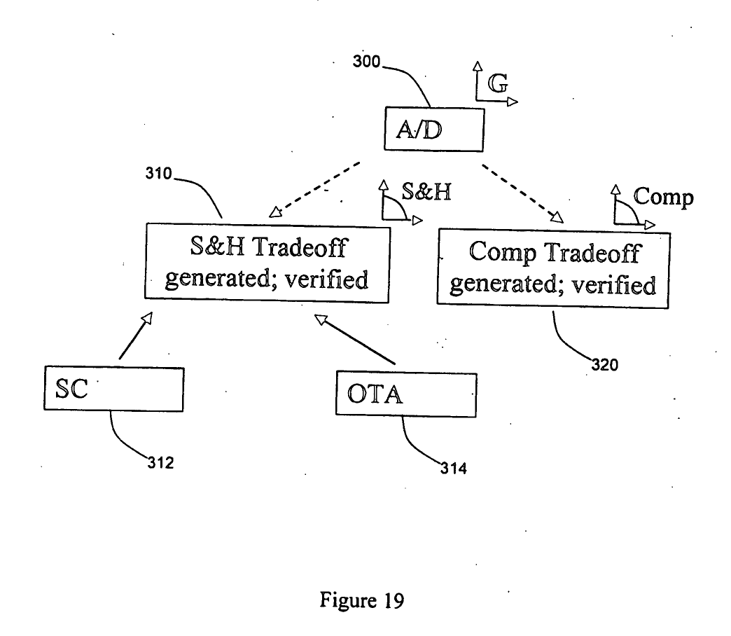

Referring to FIG. 18, the tradeoff curves for leaf nodes 312 and 314 are used to generate the design space of their parent node 310. In the example, the design space of the S&H (sample and hold circuit) 310 is the product of the tradeoff curves from nodes 312 and 314. For greater clarity, in the example, if the tradeoff curve from node 312 is T=(t1, t2) and tradeoff curve from node 314 is U={u1, u2, u3} then the product T×U={v1, v2, v3, v4, v5, v6} where v1=(t1,u1), v2=(t1,u2), v3=(t1,u3), v4=(t2,u1), v5=(t2,u2) and v6=(t2,u3)). Here, each of t1 is a point in the objective function space of node 312, each of uj is a point in the objective function space of node 314 and each of zk is a point in design space of node 310. There may also be the need for additional variables to be introduced to relate the two subcomponents, for example physical connection of two components or some other infrastructure. This additional infrastructure or “glue logic” could also contribute one or more dimensions or points to the tradeoff curve of node 310.

More generally, the generated design space contains the tradeoff curves which generate it. By this we mean that the design space includes the points of the tradeoff curves, or the product of the tradeoff curves or the product of the tradeoff curves and additional points or the union of the points of the tradeoff curves with additional points or the union of the products of the tradeoff curves with additional points. Alternatively, the design space is one in which the tradeoff curves are embedded.

Based on the resulting design space at node 310, a corresponding tradeoff curve is generated and verified. Since node 320 is a leaf node, a tradeoff curve is generated in a fashion similar to those of nodes 312 and 314.

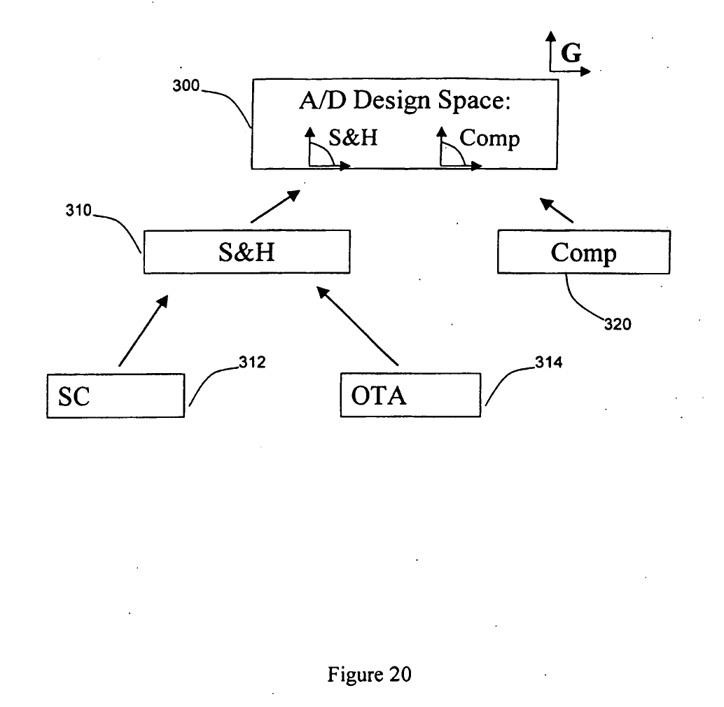

Referring to FIG. 20, the design space of node 300 is derived or generated from the tradeoff curves from nodes 310 and 320 in a similar fashion to the generation of the design space of node 310.

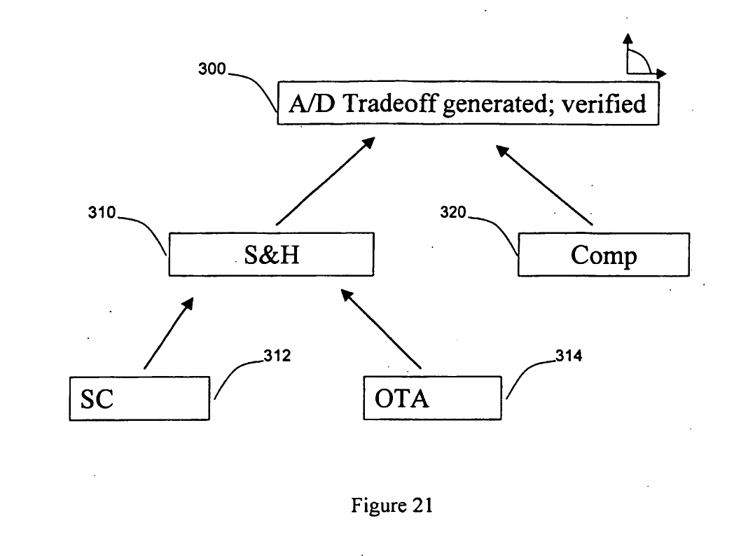

Referring to FIG. 21, at node 300 a tradeoff curve is generated for possible designs and the corresponding designs are verified.

The last step is to select a design from the (discrete) tradeoff curve. See, for example, the discrete tradeoff curve of FIG. 22.

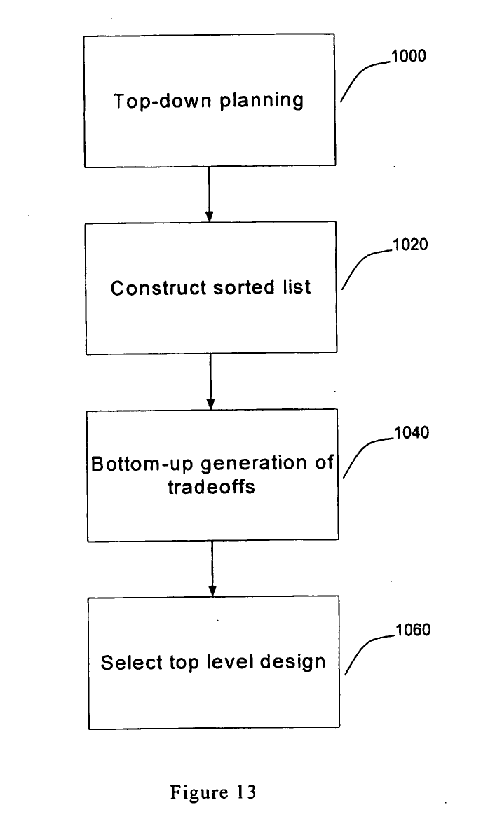

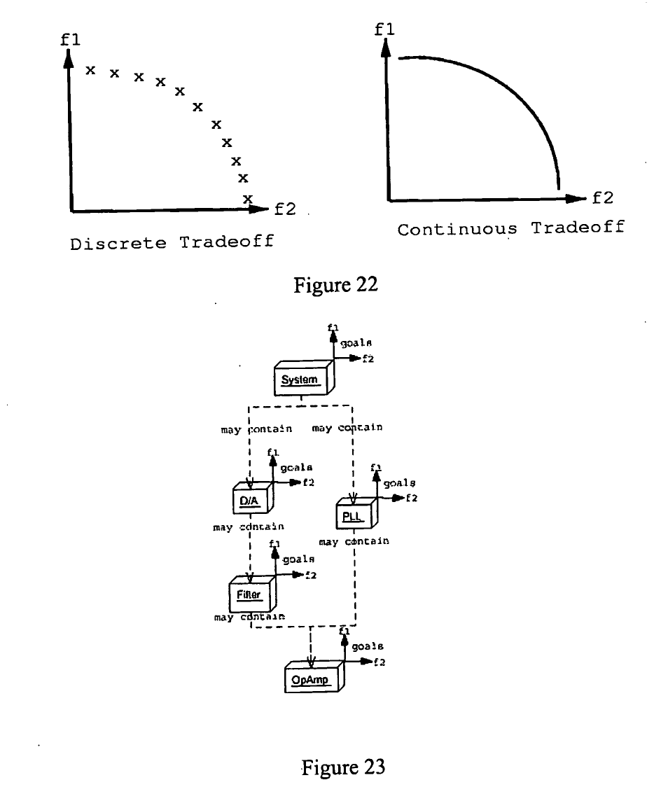

Referring to FIG. 13, according to another embodiment of the present invention, a top-down multi-objective design methodology includes the following steps: top-down planning 1000; constructing a sorted list 1020; bottom-up generation of tradeoffs 1040; and selection of top level design 1060. An example of this embodiment of the present invention is illustrated in FIGS. 23 to 30.

According to the present embodiment, the first step 1000 of top-down planning includes constructing a top-down “may contain” diagram. This diagram shows the relationship “may contain” among component types. This first step is illustrated in the diagram of FIG. 23 in which the user creates a set of “may contain” relationships among the component types. For example, component types can include filters, op amps, D/As, and PLLs.

At the very top of the diagram is the system to be designed. Near the top will be other types of large systems, with arrows pointing to smaller types of systems. Higher-level types do not have to contain the lower-level types, however; for example, a filter “may contain” op amps but does not need to. It is emphasized that this diagram has no information about architectural selection beyond the “may contain” dependencies. It is this relaxed constraint on architecture selection that allows for hierarchical synthesis. (Alternatively, if the user desires, they may pick a fixed topology or set of topologies). In addition, there should be no circular dependencies.

The diagram shows how higher-level components are dependent on the tradeoffs provided by lower-level components; the lower-level components' tradeoffs will make part of the higher-level components' design space if the lower-level component is used in the higher-level component's design.

Types of components at the level of op amps and above should have accompanying behavioral models. The parameters of the behavioral models should be the parameters found in the tradeoffs of the component type. For, example, an op amp behavioral model's parameters will include open loop gain and unity gain bandwidth.

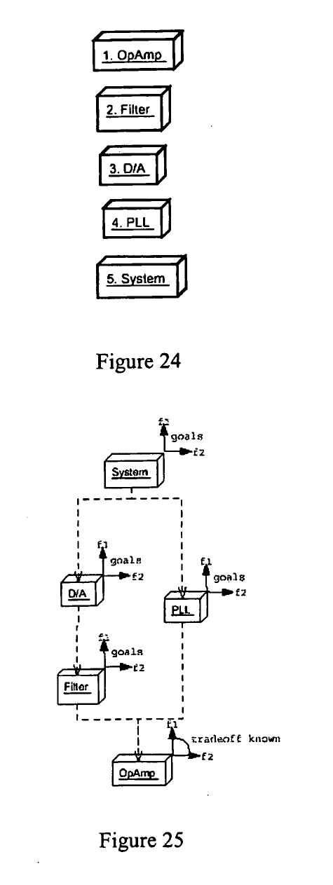

The second step 1020 includes creating a sorted list. By this we mean following the diagram beginning with a component that does not have any “may contain” dependencies (i.e. a leaf node). That will be the first item in the list. Only add a new component to the list if all the components that it may contain are already on the list. Keep adding components until all components are added. Step 1020 is illustrated in FIG. 24 in which the user creates a list of the component types. At the top of the list is the op amp, because it does not have any “may contain” dependencies on other components. At the bottom of the list is the system under design.

The third step 1040 comprises bottom-up generation of tradeoffs. For each component in the list (starting with the first component and continuing down), determine the optimal tradeoff of that component, via one of:

choosing an architecture and optimizing it; then doing layout;

choosing many architectures and optimizing each; doing layout on each;

synthesizing and optimizing to get many architectures; doing layout on each; and

using previous design and tradeoff IP stored in a database; do layout if needed.

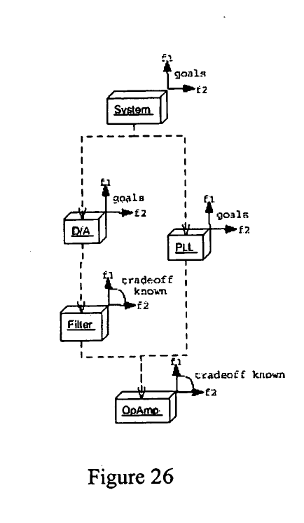

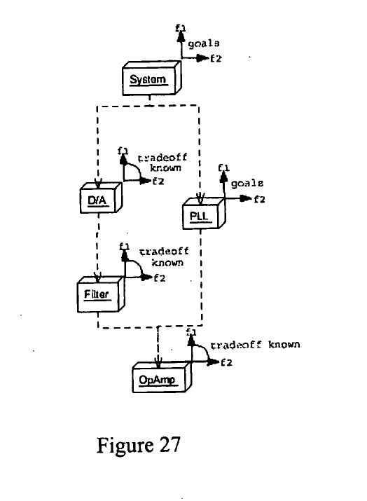

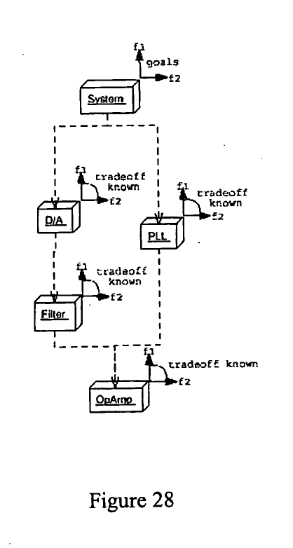

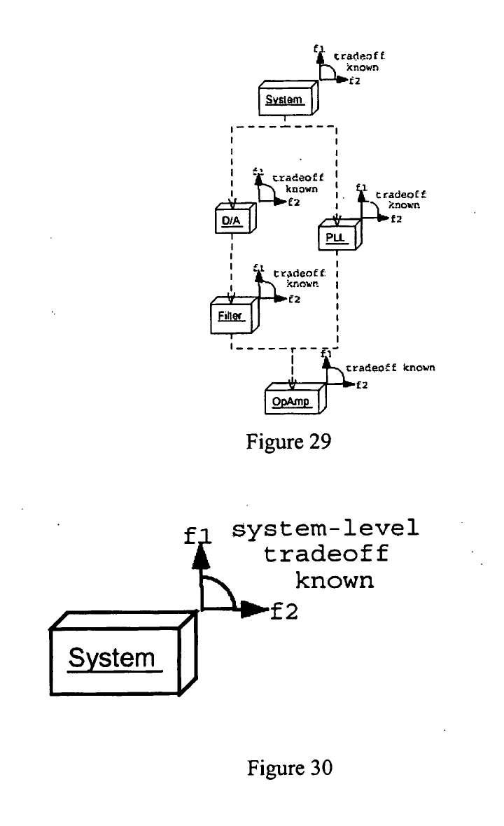

The third step is illustrated in FIGS. 25 to 29. Starting at the top of the list and proceeding downwards, the tradeoffs for the components is found. FIG. 25 illustrates the substep in which the tradeoffs for the op amp are found. FIG. 26 illustrates the substep in which the tradeoffs for the filter are found. FIG. 27 illustrates the substep in which the tradeoffs for the D/A are found. FIG. 28 illustrates the substep in which the tradeoffs for the PLL are found. FIG. 29 illustrates the substep in which the tradeoffs for the system are found. Note that in the present example, the tradeoffs are optimal ones since an optimizing step has been used. However, non-optimal tradeoffs can also be used and the invention is not dependent on either the user of an optimizer nor optimal tradeoffs.

The fourth step 1060 comprises choosing a design. When the previous step has been done for all items in the list, then the user has a tradeoff of the system to be designed and the corresponding designs. The user can make the decision based on the tradeoffs, and then the design is done. As illustrated in FIG. 30, The user selects a system-level design from the set of optimal tradeoffs presented to him/her. The user is now done.

At higher levels of the hierarchy, behavioural models of the components will be used. The goal here is not to generate a full continuous approximation among all the possible tradeoffs among all the objectives and constraints; rather, it is to generate a set of points in objective space that collectively discretely approximate the tradeoffs.

Multi-objective optimization/synthesis can generate such a set of points. Each of these points is a proven design that can be pulled from a database of designs. It is this set of discrete points in objective space for lower-level components that get used as discrete points in design space for higher-level components. The discrete approach (as opposed to the continuous approach) makes the problem of bottom-up generation of tradeoffs tractable for a large number of objectives.

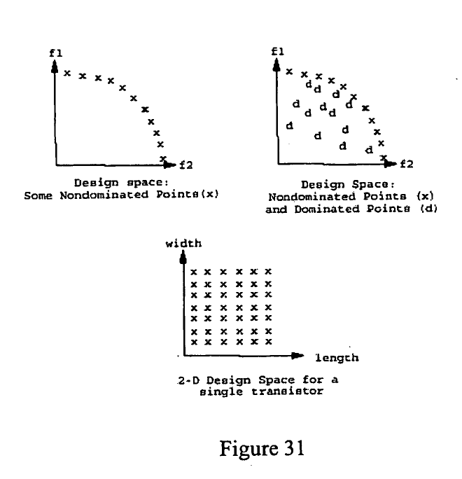

The previous example related to non-dominated design spaces. However, the present invention can easily be extended to handle other designs such as “dominated” designs, and to handle low-level design variables such as component values like length, width, resistance and matching (see FIG. 31).

This is achieved by considering a higher-level design space that includes more than just the nondominated designs of a lower-level space—it can hold any designs which are feasible. These “feasible designs” include nondominated designs, and low-level design variable spaces.

However, just having more finite points in the space may not be enough. There may be measurements of a component that are not in the tradeoff space that affect the higher level. For example, the exact shape of a layout may not be in the tradeoff curve, yet it affects layout for the higher level. And, if the exact shape is in the tradeoff curve, it may be over-restricting because there are likely many layout shapes that occupy a given point in tradeoff space, not just one shape.

One approach is to overcome this problem is to consider, for each point in the tradeoff space, a space that describes design freedoms for the higher. For example, the exact shape of a layout may have variations, but the shape is still constrained to a set of possible shapes so that those performance targets can be hit.

This methodology allows any mix of hierarchical synthesis and hierarchical optimization because it postpones architecture selection as late as possible. If the user chooses to select an architecture or architectures at any level and just optimize parameters, the user can do so. Alternatively, if the user chooses to let the design space include both topology and parameters, the system will allow that as well. Note once again that a higher-level component's “parameters” are based on its performance space at lower levels (see FIG. 32).

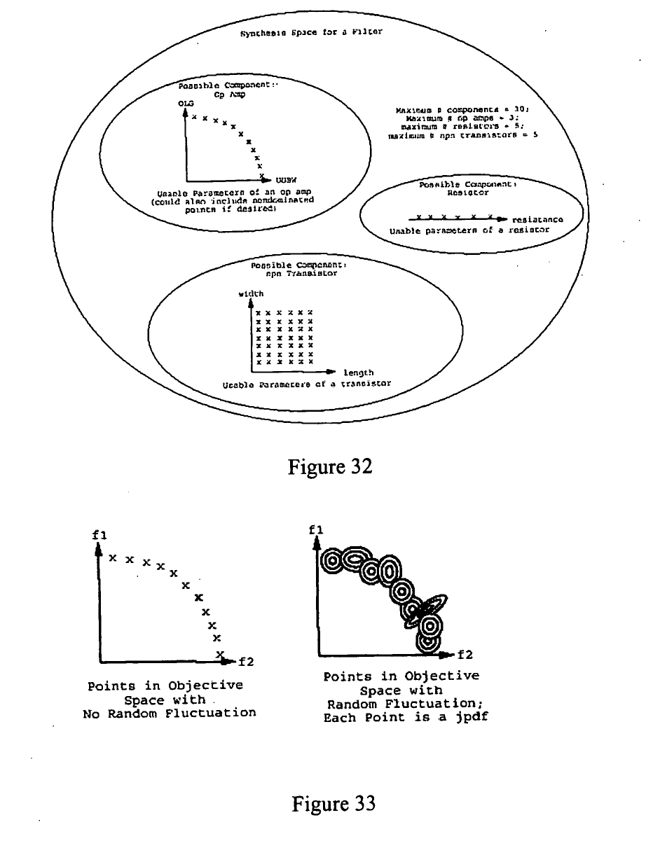

At the lowest level of the hierarchy, statisticical fluctuations arise, for example, in SPICE models and are derived elsewhere. If statistical fluctuations are modeled at that level, then there will be fluctuations at each of the higher levels as well. Each design point in the tradeoff curve does not have 100% certain performances; rather, those performances are described by a joint probability distribution function (jpdf). In this manner, jpdfs are propagated to higher and higher levels in the problem. The final system-level tradeoff is actually a set of points, with each point's system-level performances described by a jpdf. A design point chosen will reference a single jpdf. A random point would be sampled from the jpdf corresponding to that design point (see FIG. 33).

This methodology is very similar to the way that a set of managers in an organisation may operate and is applicable to management decision-making. First, the top-down question-asking occurs. The manager at the top level decides he needs to make some decisions about certain things; he knows he has certain goals. Before he makes those decisions, he wants to understand the tradeoff among the goals, and what are optimal points in tradeoff space. The top-level manager has a set of managers that report to him, for different aspects of the organization. Each of those managers has their own set of goals. The top-level manager asks each of those managers what their optimal alternatives are.

Those managers in turn go to their sub-managers, and the sub-managers go to their sub-sub-managers, and so on. Finally, “leaf” people in the organization are reached.

Then, the bottom-up question-answering occurs. When “leaf” people in the organization are reached, they tell their alternatives to their managers. The managers look at different combinations of alternatives from each person below them, to determine the set of optimal alternatives for their own level. This bottom-up question-answering continues up the levels of the hierarchy, until the top-level manager has an optimal tradeoff curve. That tradeoff curve might be, for example, company risk vs. company market capitalization vs. employee happiness. The manager then chooses from the high-level tradeoff curve to determine the direction (point in the tradeoff curve) in which the organization will go and implements an appropriate course of action.

The method of the present invention can also be used to explore different approaches or architectures. Specifically, if two (or more) approaches are possible, then a separate tree is constructed for each approach with the desired design aim having the same goals at the top or root of each tree and the same objective function. The methodology of the present invention is then applied to obtain tradeoff curves for each tree. Since the tradeoff curves are all in a similar space (e.g. all spaces have the same axes), a desired design can be selected from the union of these tradeoff curves.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium.

The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of determining a design satisfying a design aim, the method comprising:
identifying at least one candidate component of the design;
determining at least one component discrete tradeoff curve for the at least one candidate component;
generating a design space containing the at least one component discrete tradeoff curve; and
determining at least one design from the design space.

2. The method of claim 1, wherein generating a design space containing the at least one component discrete tradeoff curve comprises generating a design space containing the at least one component discrete tradeoff curve and additional infrastructure related components.

3. The method of claim 1, wherein determining at least one design from the design space comprises determining a discrete design tradeoff curve from the design space.

4. The method of claim 1 wherein determining at least one component discrete tradeoff curve for the at least one component comprises determining a component discrete tradeoff curve for each candidate component.

5. The method of claim 1, wherein determining at least one design from the design space comprises:
determining a design discrete tradeoff curve based on the design space;
identifying at least one point on the design discrete tradeoff curve; and
identifying at least one design from the design space corresponding to the at least one point on the design discrete tradeoff curve.

6. The method of claim 1, wherein identifying at least one candidate component of the design comprises identifying at least one component of the design.

7. The method of claim 1, wherein determining at least one component discrete tradeoff curve for at least one component comprises:
identifying at least one candidate subcomponent for the at least one component;
determining at least one subcomponent discrete tradeoff curve for the at least one candidate subcomponent;
generating a component design space containing the at least one subcomponent discrete tradeoff curve; and
determining at least one subcomponent design from the subcomponent design space.

8. The method of claim 7, wherein generating a component design space containing the at least one subcomponent discrete tradeoff curve comprises generating a component design space containing the at least one subcomponent discrete tradeoff curve and additional infrastructure related components.

9. The method of claim 7, wherein determining at least one component design from the component design space comprises determining a component discrete design tradeoff curve from to the component design space

10. The method of claim 7, wherein determining at least one subcomponent discrete tradeoff curve for the at least one subcomponent comprises determining a subcomponent discrete tradeoff curve for each candidate subcomponent;

11. The method of claim 7, wherein determining at least one component design from the component design space comprises:
determining a component discrete design tradeoff curve based on the component design space;
identifying at least one point on the component discrete design tradeoff curve; and
identifying at least one component design from the component design space corresponding to the at least one point on the component discrete design tradeoff curve.

12. The method of claim 1, wherein each component tradeoff curve is generated by an optimizer.

13. The method of claim 1, wherein each component tradeoff curve is a tradeoff curve of component designs.

14. The method of claim 1, wherein each component tradeoff curve is generated by a corresponding objective function and each component tradeoff curve is in a corresponding objective function space.

15. A method of designing a design aim having one or more components and subcomponents, the method comprising:
top-down planning of components and subcomponents for potential inclusion in a design;
constructing a sorted list of components and subcomponents; and
bottom-up generation of tradeoffs curves of subcomponents and using the generated tradeoffs curves of subcomponents to define a design space for a corresponding component.

16. The method of claim 15, further comprising selecting a design the top level set of tradeoffs.

17. A method of determining a design satisfying a design aim, the method comprising:
identifying a design aim;
associating goals with the design aim;
identifying one or more candidate components and subcomponents for potential inclusion in the design;
determining for each subcomponent a subcomponent tradeoff curve;
determining for each component a component design space based on its subcomponents;
determining a component tradeoff curve for each component based on the determined component design space;
determining a design space based on the component tradeoff curves; and
determining a design based on the determined design space.

18. The method of claim 17, wherein determining the design based on the determined design space comprises determining a design tradeoff curve based on the determined design space;
selecting a point on the design tradeoff curve; and
selecting a design corresponding to the selected point on the design tradeoff curve.

19. A system for determining a design satisfying a design aim, the design having one or more components, the system comprising:
means for providing a design aim to the system;
means for associating goals with the design aim;
means for identifying one or more candidate components and subcomponents for potential inclusion in the design;
means for determining a subcomponent tradeoff curve for each subcomponent;
means for determining a component design space based on the subcomponent tradeoff curves of the component's subcomponents;
means for determining, for each component, a component tradeoff curve based on the determined component design space;
means for determining a design space based on the component tradeoff curves; and
means for determining a design based on the determined design space;

20. The system of claim 19, further comprising means for representing the design tradeoff space to a user.
